(19) United States
(12) Patent Application Publication
(10) Pub. No.: US 2009/0030709 A1
(43) Pub. Date: Jan. 29, 2009

(54) PERSONNEL LISTING ANALYSIS BASED ON ORGANIZATIONAL POSITION AND ROLE

(76) Inventor: Pierre E. Arbajian, Matthews, NC (US)

Correspondence Address: HOFFMAN WARNICK LLC, 75 STATE ST, 14 FL, ALBANY, NY, 12207, US

(21) Appl. No.: 11/828,747

(22) Filed: Jul. 26, 2007

(51) Int. Cl. G06Q 99/00

(52) U.S. Cl. 705/1

(57) ABSTRACT

A system, method and program product for generating a hierarchical display of a subset of individuals from within an organization. A system is provided that includes: a merging system for comparing a list of selected individuals with a master hierarchy of individuals within the organization; a rendering system for generating a sub-hierarchy that includes a portion of the master hierarchy large enough to include each of the selected individuals; and a coding system for visually distinguishing all of the selected individuals in the sub-hierarchy from other individuals not in the list of selected individuals.

### FIELD OF THE INVENTION

This disclosure relates generally to displaying organizational information, and more particularly relates to a system and method for generating a hierarchical display of individuals participating in a meeting.

### BACKGROUND OF THE INVENTION

Communication technologies such as teleconferences and instant messaging have become increasingly important for conducting “electronic” meetings within large organizations. Often, it is not unusual to have dozens if not hundreds of people from within an organization attending such meetings.

Determining and understanding what role each of the individuals plays within the organization can be critical to providing an efficient meeting. For example, knowing whether the person speaking is a high level manager or low level technician will allow listeners to gauge the importance of the speaker.

Currently, there are no tools for facilitating this process.

### SUMMARY OF THE INVENTION

The present disclosure relates to a system, method and program product which processes a list of individuals from an organization attending a meeting and identifies each individual's respective role and graphically displays the relationship amongst the various individuals in a graphical organizational chart. The result provides instant insight about attendees by providing an organizational hierarchical view of the audience at a glance. Such functionality could also be used by the organizer of the meeting to quickly identify discrepancies in the list of invitees to ensure that the right roles within the organization are represented.

In one embodiment, there is a sub-hierarchy generation system for generating a hierarchical display of a subset of individuals from within an organization, comprising: a merging system for comparing a list of selected individuals with a master hierarchy of individuals within the organization; a rendering system for generating a sub-hierarchy that includes a portion of the master hierarchy large enough to capture each of the selected individuals; and a coding system for visually distinguishing all of the selected individuals in the sub-hierarchy from other individuals not in the list of selected individuals.

In a second embodiment, there is a computer program product stored on a computer readable medium for generating a hierarchical display of a subset of individuals from within an organization, comprising: program code for comparing a list of selected individuals with a master hierarchy of individuals within the organization; program code for generating a sub-hierarchy that includes a portion of the master hierarchy large enough to capture each of the selected individuals; and program code for visually distinguishing all of the selected individuals in the sub-hierarchy from other individuals not in the list of selected individuals.

In a third embodiment, there is a method for generating a hierarchical display of a subset of individuals from within an organization, comprising: inputting a list of selected individuals from within an organization; comparing the list of selected individuals with a master hierarchy of individuals within the organization; generating a sub-hierarchy that includes a portion of the master hierarchy large enough to capture each of the selected individuals; visually distinguishing all of the selected individuals in the sub-hierarchy from other individuals not in the list of selected individuals; and outputting the sub-hierarchy.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having sub-hierarchy generation system in accordance with an embodiment of the present invention.

FIG. 2 depicts an organizational hierarchy in accordance with an embodiment of the present invention.

FIG. 3 depicts a final sub-hierarchy in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

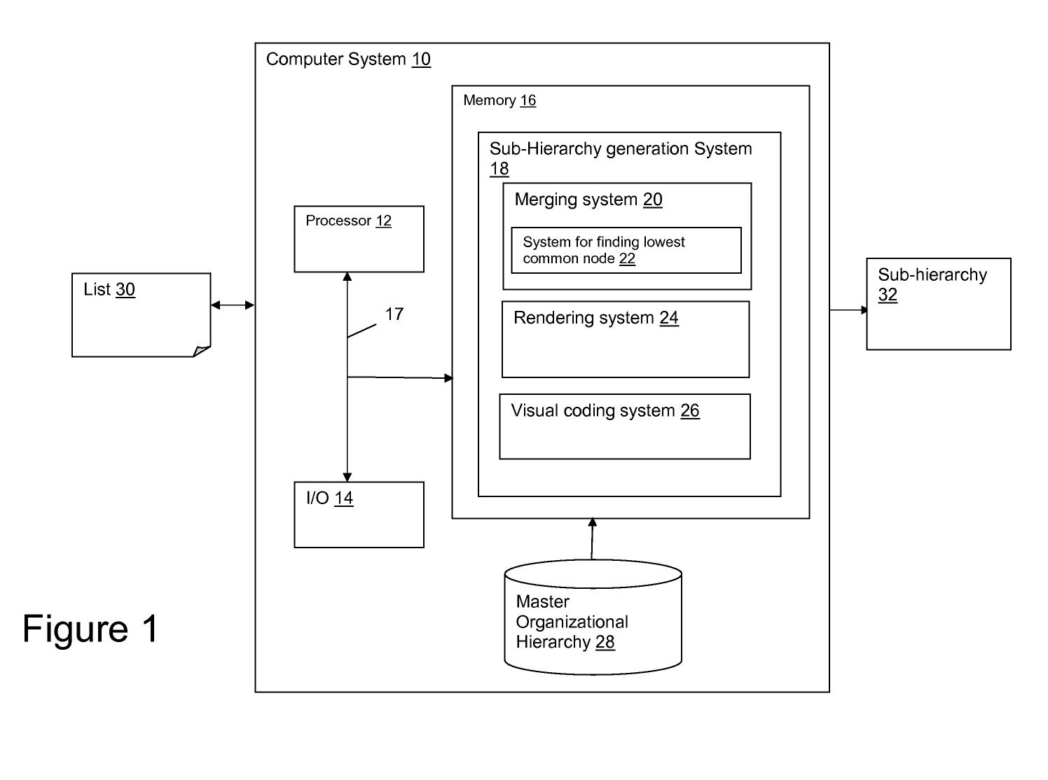

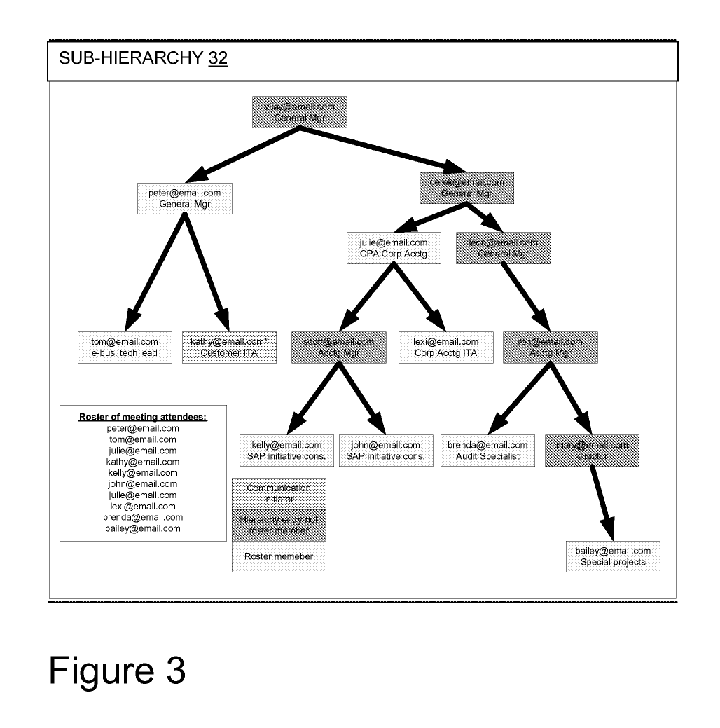

Referring now to the drawings, FIG. 1 depicts a computer system 10 having a sub-hierarchy generation system 18 that receives as input a list 30 of individuals from an organization, and generates as output a sub-hierarchy 32, such as that shown in FIG. 3. List 30 generally comprises a subset of people belonging to the organization, e.g., a group of people from the organization being invited to a meeting, a group of people from the organization participating in a meeting, etc. List 30 may be inputted in any manner and provide names in any format, e.g., a list of email address on an email invite, employee IDs selected from a drop down menu, a roster, etc.

Sub-hierarchy 32 provides a graphical or textual summary of the roles and hierarchical placement of the individuals in the list 30. In a large organization, there may be thousands of employees, with dozens of hierarchical levels in a master organizational hierarchy 28. Often, a master organizational hierarchy 28 is maintained by the organization in a database. Sub-hierarchy generation system 18 pares down the entire master organizational hierarchy 28 into a targeted sub-hierarchy 32 that can be displayed and viewed in a manageable format. In one illustrative embodiment described below, sub-hierarchy 32 is generated so that it is “just large enough” to capture all the members of the inputted list 30.

Sub-hierarchy generation system 18 includes: a merging system 20 that compares the inputted list 30 with a master organizational hierarchy 28 to identify the role and hierarchical position of each person in the list 30; a sub-hierarchy rendering system 24 that generates a visual representation (e.g., graphical or tabular) of a sub-hierarchy 32 that includes a portion of the master organizational hierarchy 28 large enough to capture each of the individuals in the list; and a visual coding system 26 that visually distinguishes individuals in the sub-hierarchy, e.g., based on whether they are in the list 30.

As noted, merging system 20 compares the inputted list 30 with a master organizational hierarchy 28 to identify the role and hierarchical position of each person in the list 30. As part of this process, merging system 20 includes a system 22 for finding a lowest common node in the master organization hierarchy 28 necessary to complete the sub-hierarchy 32. The lowest common node represents the lowest person in the master organization hierarchy 28 that is an ancestor for all of the people in the list 30. Note that the lowest common node is not necessarily a person in the list 30.

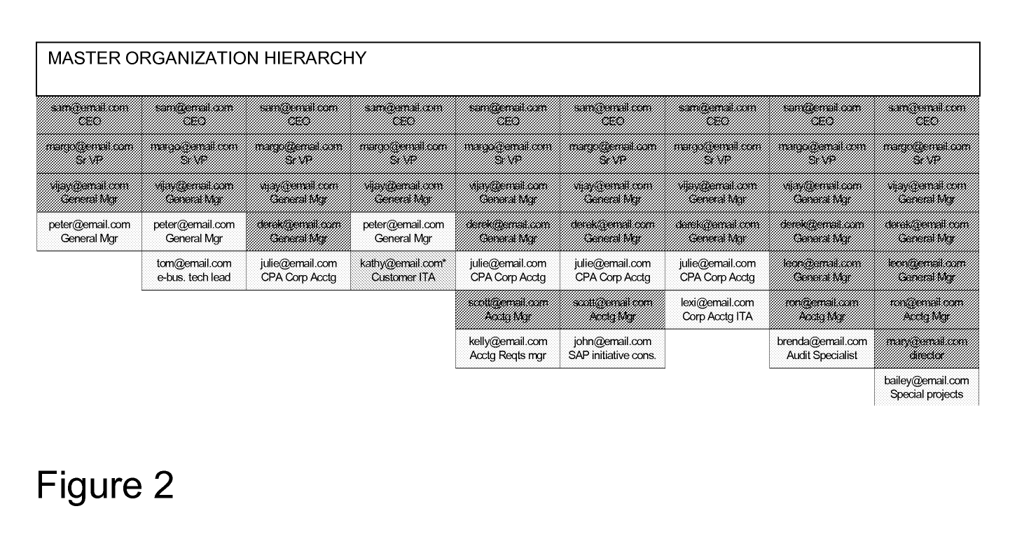

For instance, FIG. 2 depicts an illustrative master organization hierarchy 28 that shows the hierarchical lineage for each individual in an organization. For example, it can be seen that Kelly (i.e., kelly@email.com) reports to Scott, who reports to Julie, who reports to Derek, who reports to Vijay, who reports to Margo, who reports to Sam. Assume for example that the following list 30 was submitted to sub-hierarchy generation system 18:

peter@email.com

tom@email.com

julie@email.com

kathy@email.com

kelly@email.com

john@email.com

brenda@email.com

bailey@email.com

lexi@email.com

In FIG. 2, each of the listed names is highlighted. In this case, the lowest common node for all of the names in the list 30 would be Vijay (i.e., vijay@email.com), since Vijay is the lowest ancestor for each person in the list 30. Once merge system 20 identifies the lowest common node, merge system 20 can identify each person who belongs in the sub-hierarchy 32 by collecting the complete lineage between each person in the list 30 up to the lowest common node. For example, for kelly@email.com, merge system 20 would identify kelly@email.com, scott@email.com, julie@email.com, derek@email.com and vijay@email.com as a lineage that should appear in the sub-hierarchy. A similar collection process would be done for each person in the list 30. Note that there may be people in the middle of a lineage that are not in the list 30.

Once merge system 20 determines all of the lineages that belong to sub-hierarchy 32, rendering system 24 generates a visual representation of the sub-hierarchy 32, as shown in FIG. 3. As can be seen, vijay@email.com appears at the top as the lowest common node, and then individuals in the list 30, and not in the list 30, populate the sub-hierarchy 32. In addition, each node includes a role assigned to each person (e.g., general mgr, acctg magr, etc.).

Visual coding system 26 is utilized to visually distinguish the individuals that were in the list 30 from individuals were not in the list 30 within the sub-hierarchy 32. Nodes in the sub-hierarchy 32 can be visually distinguished in any manner, e.g., using different colors, shading, textures, etc. In addition, the individual who initiated to meeting (e.g., submitted the list) can be further distinguished. Thus, as can be seen in FIG. 3, those people in the darker shaded boxes were not in the list 30, those in the light shaded boxes were in the list 30, and the medium shaded box (i.e., kathy@email.com) represents the communication initiator.

Thus, the described embodiments allow for someone to view a collection of individuals who were invited to a meeting, copied on an email, etc., and know their organizational roles as well as their hierarchical position. The resulting outputted sub-hierarchy 32 identifies each individual's respective role and graphically display the relationship amongst the various individuals in a graphical organizational chart.

Such a process provides instant insight about a group of individuals and provides the inquirer at a glance a full organizational hierarchical view of the audience. Such functionality is also of value in a context where a individual sending a meeting invite could submit a list of individuals and quickly identify discrepancies in the invitees, where the list does not contain invitees in the right role or organization.

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising a sub-hierarchy generation system 18 could be created, maintained and/or deployed by a service provider that offers the functions described herein for customers. That is, a service provider could offer to deploy or provide the ability to generate a sub-hierarchy as described above.

It is understood that in addition to being implemented as a system and method, the features may be provided as a program product stored on a computer-readable medium, which when executed, enables computer system 10 to provide a sub-hierarchy generation system 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A sub-hierarchy generation system for generating a hierarchical display of a subset of individuals from within an organization, comprising:
a merging system for comparing a list of selected individuals with a master hierarchy of individuals within the organization;
a rendering system for generating a sub-hierarchy that includes a portion of the master hierarchy large enough to capture each of the selected individuals; and
a coding system for visually distinguishing all of the selected individuals in the sub-hierarchy from other individuals not in the list of selected individuals.

2. The sub-hierarchy generation system of claim 1, wherein the merging system identifies a lowest common node within the master hierarchy, wherein the lowest common node is an individual in a lineage of each of the list of selected individuals.

3. The sub-hierarchy generation system of claim 2, wherein the common node appears at a top of the sub-hierarchy.

4. The sub-hierarchy generation system of claim 1, wherein the rendering system displays a role for each individual within the sub-hierarchy.

5. The sub-hierarchy generation system of claim 1, wherein the coding system displays the selected individuals in a unique color.

6. A computer program product stored on a computer readable medium for generating a hierarchical display of a subset of individuals from within an organization, comprising:
program code for comparing a list of selected individuals with a master hierarchy of individuals within the organization;
program code for generating a sub-hierarchy that includes a portion of the master hierarchy large enough to capture each of the selected individuals; and
program code for visually distinguishing all of the selected individuals in the sub-hierarchy from other individuals not in the list of selected individuals.

7. The computer program product of claim 6, wherein the program code for comparing identifies a lowest common node within the master hierarchy, wherein the lowest common node is an individual in a lineage of each of the list of selected individuals.

8. The computer program product of claim 7, wherein the common node appears at a top of the sub-hierarchy.

9. The computer program product of claim 6, wherein the program code for generating a sub-hierarchy displays a role for each individual within the sub-hierarchy.

10. The computer program product of claim 6, wherein the selected individuals are displayed in a unique color.

11. The computer program product of claim 6, wherein the selected individuals are inputted as a list of email addresses.

11. A method for generating a hierarchical display of a subset of individuals from within an organization, comprising:
inputting a list of selected individuals from within an organization;
comparing the list of selected individuals with a master hierarchy of individuals within the organization;
generating a sub-hierarchy that includes a portion of the master hierarchy large enough to capture each of the selected individuals;
visually distinguishing all of the selected individuals in the sub-hierarchy from other individuals not in the list of selected individuals; and
outputting the sub-hierarchy.

12. The method of claim 11, wherein the comparing identifies a lowest common node within the master hierarchy, and wherein the lowest common node is an individual in a lineage of each of the list of selected individuals.

13. The method of claim 12, wherein the common node appears at a top of the sub-hierarchy.

14. The method of claim 11, wherein a role for each individual within the sub-hierarchy is displayed.

15. The method of claim 11, wherein the selected individuals are displayed in a unique color.
